(19) United States
(12) Patent Application Publication
(10) Pub. No.: US 2009/0277707 A1
(43) Pub. Date: Nov. 12, 2009

(54) ELECTRICALLY PROPELLED VEHICLE HAVING ELECTRIC SOUND-PRODUCING BLOWER/COOLER

(76) Inventor: CLAUDIO R. BALLARD, HUNTINGTON, NY (US)

Correspondence Address: HOWISON & ARNOTT, L.L.P, P.O. BOX 741715, DALLAS, TX, 75374-1715, US

(21) Appl. No.: 12/464,710

(22) Filed: May 12, 2009

Related U.S. Application Data
(60) Provisional application No. 61/052,510, filed on May 12, 2008.

(51) Int. Cl. B60K 11/06; G08B 3/10

(52) U.S. Cl. 180/68.2; 340/384.3

(57) ABSTRACT

An apparatus for simulating the sound of a conventionally powered gasoline or diesel powered engine in an electrically powered passenger vehicle having an electric drive motor operatively coupled to one or more of the vehicle's wheels for rotating the vehicle's wheels to propel the vehicle, includes a rotary air mover and sound generator for supplying cooling air to the electric drive motor and for generating a variable sound having at least one variable sound parameter, a motor for driving the rotary air mover and sound generator; and a controller for controlling the rotary air mover and sound generator, the controller controlling the rotary air mover and sound generator to change the variable parameter of sound generated by the rotary air mover and sound generator such that the sound parameter of sound generated by the rotary air mover and sound generator matches a selected one of the vehicle's performance parameters.

### CROSS-REFERENCE TO RELATED APPLICATIONS

This application is a non-provisional patent application of U.S. Provisional Application for Patent Serial No. 61/052,510, filed May 12, 2008, and entitled ELECTRICALLY PROPELLED VEHICLE HAVING ELECTRIC SOUND-PRODUCING BLOWER/COOLER, the specification of which is incorporated herein in its entirety.

### TECHNICAL FIELD

The following disclosure relates to electrically powered vehicles and in particular, an electrically powered vehicle having a rotating blower/cooler for providing an engine or turbine-like sound while supplying cooling air to the electrically powered components of a vehicle.

### BACKGROUND

A combination of factors including ever-increasing energy costs, environmental concerns and the development of new battery technology has revived interest in electrically powered automobiles. Currently, electric cars using “plug-in” technology are available that have a driving range of 200 or more miles per day and performance rivaling or exceeding conventional vehicles powered with gasoline or diesel fuels. Hybrid vehicles using a combination of an electric drive with a conventional gas or diesel engine are also receiving more attention. One characteristic of plug-in electrically powered vehicles is that the vehicles generate little or no engine sound. Similarly, hybrid electric vehicle produce little or no sound when operated in the electric mode.

However, drivers (and pedestrians) are familiar with the sound generated by conventional automobiles. The sound generated by a gasoline or diesel powered engine is appealing to a large number of drivers and consumers that equate the engine sound with power and performance. Further, the sound generated by the engines of conventional diesel and gasoline powered vehicles often alerts pedestrians, pets and wild animals to the approach of the vehicle.

Electrically powered automobiles utilizing both plug-in and hybrid technology require large battery packs, powerful electric motors and motor controllers to provide satisfactory performance. Such battery packs, motors and controllers generate a substantial amount of heat that must be dissipated to avoid damage. Thus, there exists a need for an electrically powered automobile having a combination air mover and sound generator that provides audible simulation while providing sufficient cooling to the vehicle's electrical components.

### SUMMARY

According to the disclosure, an electrically powered vehicle includes an electric drive motor operatively coupled to one or more of the vehicle's wheels for rotating the vehicle's wheels to propel the vehicle. The electric drive motor is powered with a battery or battery pack or for supplying power to the electric drive motor that is controlled with a motor controller. In one aspect a rotary air mover and sound generator having an air inlet and air outlet provides cooling air to the electric drive motor while generating a sound having at least one variable parameter as the vehicle moves. The rotary air mover and sound generator is driven with a blower motor and controlled with a speed controller that varies the speed of the rotary air mover and sound generator to vary the variable parameter of the sound generated by the rotary air mover and sound generator so that the parameter of sound generated by the rotary air mover and sound generator change with one of the vehicle's parameters. The vehicle performance parameter may be one of the vehicle's speed, acceleration, deceleration, throttle position and the speed of the vehicle's drive motor. The variable sound parameters may include volume, frequency, constant tone, variable tone and interrupted tone. In one embodiment, the rotary air mover and sound generator is one of an axial fan or a centrifugal blower. In another aspect, a resonating chamber is connected to the outlet of the rotary air mover and sound generator.

In another aspect, an apparatus for simulating the sound of a conventionally powered gasoline or diesel powered engine in an electrically powered passenger vehicle having an electric drive motor operatively coupled to one or more of the vehicle's wheels for rotating the vehicle's wheels to propel the vehicle includes a rotary air mover and sound generator mounted on the vehicle. The apparatus is configured to supply cooling air to the electric drive motor and to generate a variable sound having at least one variable sound parameter. A motor is provided for driving the rotary air mover and sound generator along with a controller for controlling the rotary air mover and sound generator. In one embodiment, the controller controls the rotary air mover and sound generator to change the variable parameter of sound generated by the rotary air mover and sound generator such that the sound parameter of sound generated by the rotary air mover and sound generator matches a selected one of the vehicle's performance parameters. The variable parameter of sound may be frequency, volume, tone or pitch.

In one variation, the controller controls the rotary air mover and sound generator such that a sound parameter of the sound generated by the rotary air mover and sound generator varies linearly with one of the speed or acceleration of the vehicle. In another embodiment, the controller controls the rotary air mover and sound generator such that a sound parameter of the sound generated by the rotary air mover and sound generator varies non-linearly with one of the speed or acceleration of the vehicle.

In another aspect, the rotary air mover and sound generator comprises an axial fan having adjustable pitch blades and wherein the sound parameter is varied by changing the pitch of the blades of the axial fan or varying the distance between the blades of the fan and/or the distance between the blades and the outlet cut-off. The sound parameter may also be varied by changing the speed of the axial fan in response to a change in the speed of the vehicle or the acceleration of the vehicle. In another variation, the rotary air mover and sound generator comprises a centrifugal blower and wherein the sound parameter is varied by changing the speed of the blower.

### BRIEF DESCRIPTION OF THE DRAWINGS

For a more complete understanding, reference is now made to the following description taken in conjunction with the accompanying Drawings in which:

FIG. 1 illustrates an electrically driven vehicle employing a the combination air mover and sound generator according to the disclosure;

FIG. 2 is a graph illustrating the relationship between motor or vehicle speed and the volume of sound generated by the combination air mover and sound generator of FIG. 1 in one embodiment;

FIG. 3 is a graph illustrating the relationship between vehicle acceleration/deceleration and the volume of sound generated by the combination air mover and sound generator of FIG. 1 in one embodiment;

FIG. 4 is a graph illustrating the relationship between vehicle speed or motor speed and the pitch or frequency of sound generated by the combination air mover and sound generator of FIG. 1 in one embodiment;

FIG. 5 is a graph illustrating a simulated shifting sound generated by the combination air mover and sound generator of FIG. 1;

FIG. 6 is a graph illustrating a pulsed or interrupted tone or volume generated by the combination air mover and sound generator of FIG. 1;

FIG. 7 illustrates an electrically driven vehicle employing an alternate configuration of the combination air mover and sound generator according to the disclosure; and

FIG. 8 illustrates an electrically driven vehicle wherein the air mover and sound generator is mounted on the exterior of the vehicle.

### DETAILED DESCRIPTION

Referring now to the drawings, wherein like reference numbers are used herein to designate like elements throughout, the various views and embodiments of electrically propelled vehicle having electric sound-producing blower/cooler are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

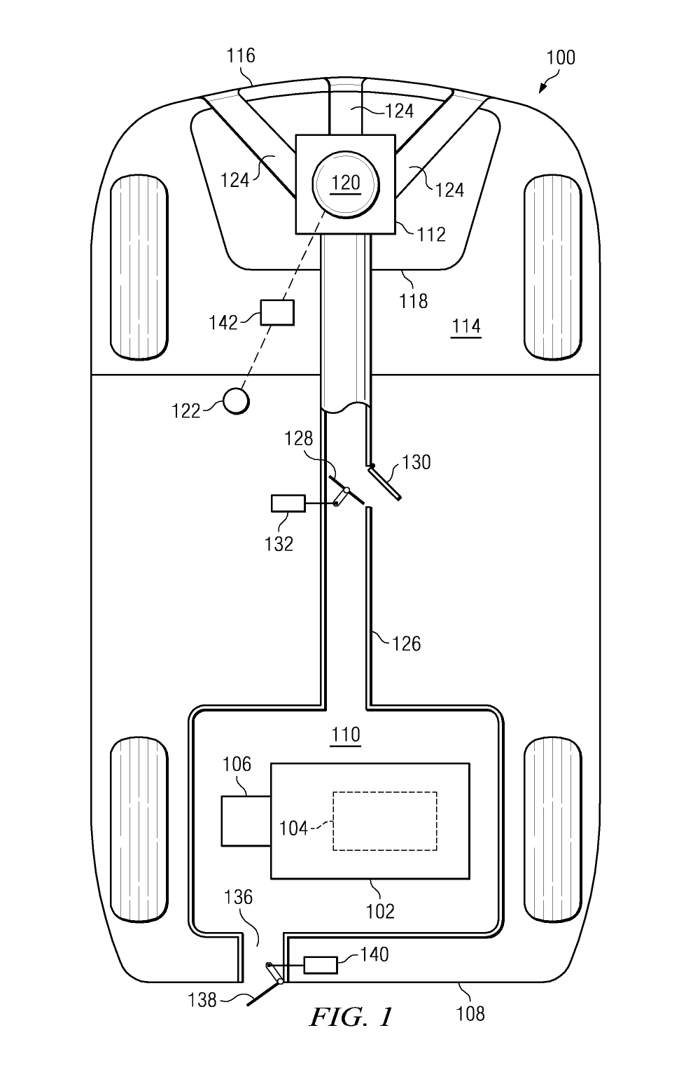

Referring to FIG. 1, in one embodiment an electrically powered vehicle 100 includes a battery or battery pack 102, an electric drive motor 104 and a motor controller package 106. As used herein, an “electrically powered vehicle” or “electrically driven vehicle” includes plug-in and hybrid vehicles capable of transporting human passengers and having one or more electric motors that supply rotary power to the vehicle's wheels to propel the vehicle. As illustrated, an electric drive motor 104 is mounted at the rear 108 of the vehicle with battery pack 102 and motor controller 106 mounted in a compartment 110 above the electric motor. In other variations, battery pack 102, motor 104 and controller package 106 may be mounted at alternative positions in the vehicle, for example in the front of the vehicle or in a mid-body motor configuration or at different locations in the vehicle. Motor controller 106 is connected to operator controls (not shown) for energizing the drive motor and controlling the speed of the motor and vehicle.

Referring still to FIG. 1, a rotary blower and sound generator 112 is mounted in a compartment 114 at the front 116 of the vehicle. In one embodiment, blower 112 is selected to generate sounds that simulate the noise generated by a high-speed turbine or a high performance conventionally fueled engine operating at high revolutions per minute (rpm). Vehicle 100 may include an access door 118, similar to the hood of a conventional gasoline or diesel powered vehicle, for providing access to blower 1 12. In other embodiments, blower 112 may be mounted at different locations on the vehicle, for example on the underside of vehicle 110 or in an air duct that opens through the body of the vehicle. In other embodiments, blower 112 may be mounted on the exterior of the vehicles body, for example on a body panel behind the passenger compartment.

Blower 112 may be an axial fan-type blower or a centrifugal blower depending on the particular design. Axial fans move air in a direction parallel to the shaft of the fan with fixed or variable pitched blades. Axial fans are used in many applications from cooling fans for personal computers to multi-stage axial fans used to provide compressed air in modem jet engines.

In one embodiment, blower 112 is driven directly, or indirectly (e.g., though a belt or gearbox), with an electric blower motor 120 mounted on or adjacent the blower in compartment 114. In one embodiment, motor 120 is a variable speed direct current motor. In other embodiments, motor 120 may be an AC motor with a variable frequency drive for speed control. Electrical power for blower motor 120 may be supplied from battery pack 102.

As previously noted, blower 112 may be an axial fan-type blower or a centrifugal blower. Sound parameters such as the volume (dB) and frequency (Hz) of sound generated by an axial fan may be a function of a number of variables including the speed of the fan, the number of blades and the blade design. The configuration and impedance of the fan inlet and outlet as well as the distance between the blade tips and the fan housing or other structures also affects the characteristics of the sound generated by axial fans. Thus, in the cases where blower 112 is an axial fan volume and frequency of sound generated by the blower can be controlled by varying these parameters.

Alternatively, blower 112 may be a centrifugal blower. Centrifugal blowers typically receive air along a path parallel to a rotating drive shaft and move air in a direction perpendicular to the rotating drive shaft. Centrifugal blowers are used in a wide variety of applications. “Squirrel cage” centrifugal blowers are used to move air in air conditioning and heating units. Centrifugal blowers are also used in vacuum cleaners as well as in turbochargers and superchargers to increase the flow of air to internal combustion engines.

As in the case of axial flow fans, the frequency (Hz) and volume (dB) and of sound generated by an centrifugal blower is a function of a number of variables including the impeller design and speed and the distance between impeller and the cut off at the blower outlet. The design of the impeller housing as well as the configuration and impedance of the blower inlet and outlet also impact the amount and frequency of sound generated by a centrifugal blower. Consequently, when a centrifugal blower is selected for use as blower 112, the frequency and volume of sound generated with the blower may be controlled by varying these parameters.

Referring still to FIG. 1, in one embodiment, blower 112 may be actuated with a manually operated switch 122. When a driver of vehicle 100 wishes to energize blower 112 he or she moves switch 122 to the on position at which time motor 120 is energized. In other embodiments, switch 122 is automatically actuated when vehicle 100 begins to move or when vehicle motor 104 is energized.

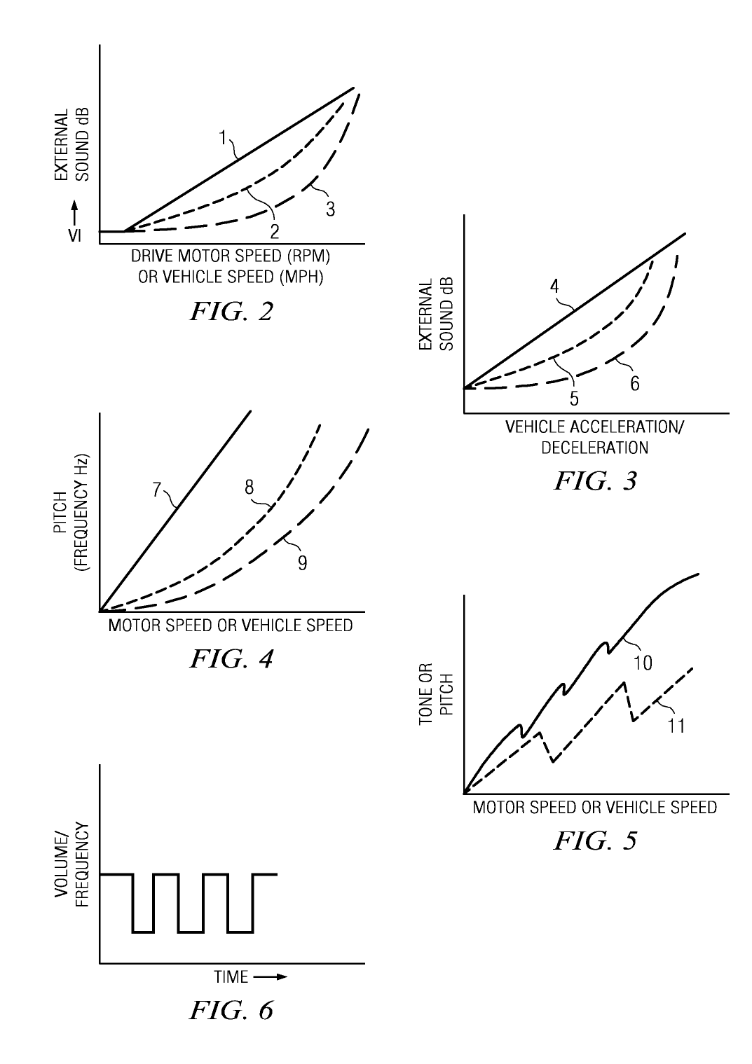

Turning to FIG. 2, in one embodiment, when switch 122 is moved to the on position, motor 120 is energized and controlled to operate blower 122 at a base speed “B1” such that the blower produces a base volume of sound “V1.” “V1” may be selected to generate a sound level that is audible over a predetermined distance, for example fifty feet. In this manner, pedestrians and pets would be alerted even if vehicle 100 was stopped at a stop sign or red light. In other embodiments, motor 120 is not energized until the vehicle begins to move.

As illustrated, the speed of motor 120 and/or blower 112 may be controlled to increase proportionally with the speed of vehicle motor 104 by means of a motion sensor that measures wheel or axle speed. Alternatively, the speed of motor 120 and/or blower 112 may be controlled by means of a sensor that detects the revolutions per minute of vehicle motor or the power supplied to vehicle motor. Thus, as illustrated, the volume (dB) and frequency (Hz) of sound generated by blower 112 increases as the speed of the vehicle increases or the rpm of drive motor 104 increases. In one embodiment, the volume of sound increases linearly with speed as illustrated by line 1. In other embodiments, the volume of sound increases non-linearly as illustrated by lines 2 and 3. In still other embodiments, the driver may select between different sound vs. speed profiles (e.g., lines 1, 2 or 3) by means of a selector switch (not shown) connected to the blower motor 120 or microprocessor 142 (FIG. 1).

Referring to FIG. 3, the speed of motor 120 and/or blower 112 may be controlled to increase or decrease the volume of sound generated proportionally to the vehicle's acceleration. In one variation, the volume of sound may be a linear function of the vehicle's acceleration and or deceleration as indicated by line 4, or alternatively may be a non-linear function of the vehicle's acceleration or deceleration as illustrated by lines 5 and 6. Further, the volume and pitch may be varied depending upon whether the vehicle is accelerating or decelerating to simulate the different sounds generated by a conventionally fueled vehicle as it accelerates versus when it decelerates. In still other embodiments, the driver may select between different sound vs. acceleration profiles (e.g., lines 4, 5 or 6) by means of a selector switch (not shown) connected to the blower motor 120 or microprocessor 142.

Referring to FIG. 4, the tone or pitch of the sound generated by motor 120 and/or blower 112 vary linearly with the speed of vehicle 100, the speed of drive motor 104 or the position of the manual speed controller or throttle used by the driver. This effect may be linear as illustrated by line 7, or non-linear as illustrated by lines 8 and 9. In still other embodiments, the driver may select between different pitch vs. speed profiles (e.g., lines 7, 8 or 9) by means of a selector switch (not shown) connected to the blower motor 120 or microprocessor 142.

Turning to FIG. 5, sound parameters such as the tone, pitch or volume of the sound created by motor 120 and/or blower 112 may be varied in a “stepped” fashion vs. speed/acceleration to simulate the sound of a conventionally fueled vehicle as it is shifted, either manually or by means of an automatic transmission. This effect may be accomplished by changing the speed of motor 120 and/or blower 112 or alternatively by opening or closing a damper at the inlet or outlet of the blower or in a duct connected to the blower. The volume or frequency or the sound generated by motor 120 and/or blower 112 may also be controlled in the case where blower 112 is an axial fan by changing the pitch of the blades or varying the distance between the blades and the blower's housing or a structure adjacent the blades such as a baffle or plate. In the case of a centrifugal blower, the pitch of the blades and the distance between the impeller and cut-off at the air outlet may be changed to vary the volume or frequency of the sound. In some embodiments, the driver may select between shifting sound profiles (e.g., lines 10 or 11) by means of a selector switch (not shown) connected to the blower motor 120 or microprocessor 142.

Turning to FIG. 6, in yet another variation, the volume and/or frequency of sound generated by motor 120 and/or blower 112 may be pulsed or interrupted to create different audible effects. This effect may be created by, for example, rapidly opening or closing a damper at the inlet or outlet of blower 112 or in ducts connected to the inlet or outlet of the blower. Other means of achieving the pulsed or interrupted sound are possible.

Referring again to FIG. 1, in one variation, one or more inlet ducts 124 may be employed to direct air to the inlet of blower 112. Inlet ducts 124 may open at the front end 116 of vehicle 100 or may be connected to one or more scoops (not shown) in hood 118 of vehicle 100. In one embodiment, ducts 124 may be designed and configured to resonate at a desired frequency to enhance the audible effect of blower 112.

One or more exhaust ducts 126 may conduct air from blower 112 to drive motor 120 and/or to compartment 110 to cool motor controller 106 and battery pack 104. Compartment 110 may be provided with an exhaust outlet 136 to facilitate the flow of air through the compartment. Outlet 136 may be provided with a damper 138 that is positioned with a manual or electric actuator 140 to position the damper. Inlet ducts 124 and exhaust ducts 126 may be configured with baffles, restrictions, expansion chambers or other features to resonate at a desired frequency or otherwise affect the sound generated by blower 110.

In one embodiment, a valve or damper 128 may direct air from exhaust duct 126 though an outlet 130 in exhaust duct 126. Damper 128 and/or outlet 130 may be opened and closed with an actuator 132. Actuator 132 may be an electrically powered linear actuator or rotary actuator such as a stepper motor. In one variation, pressurized air from outlet 130 may be directed into the vehicle's passenger compartment for ventilation. In this variation, pressurized air from outlet 130 may be passed across a heating or cooling element to heat or cool the vehicle's passenger compartment.

Damper 128 may be used to control the amount of cooling air supplied to drive motor 104 as well as motor controller 106 and battery pack 102. Damper 128 may also be used to vary the volume and/or frequency of sound generated by blower 112. In one variation, the signal from one or more temperature sensors positioned on or adjacent to drive motor and/or in compartment 110 may be utilized to control the position of damper 128. Alternatively, damper 128 may be located in inlet duct 124 and or at the inlet of blower 112 to regulate the amount of air flowing into the blower. In one embodiment, the speed of blower motor 120, and the position of actuators 132 and 140 are controlled with an onboard microprocessor 142 that is programmed to respond to changes in the speed of the drive motor or vehicle's speed as well as the temperature in compartment 110 and/or the temperature of drive motor 104.

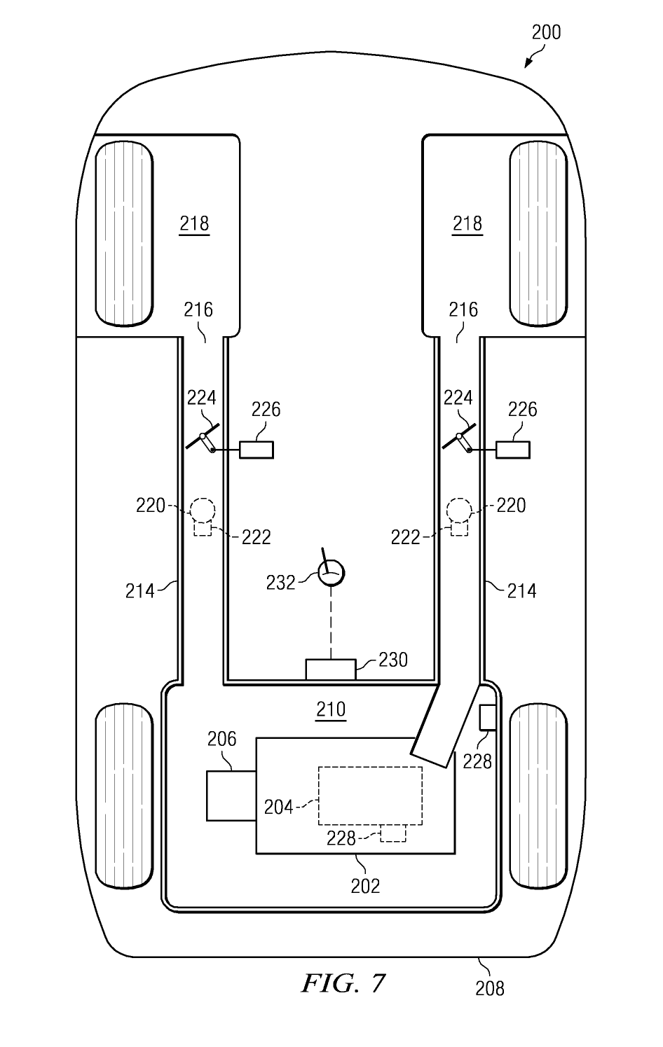

Referring now to FIG. 7, in an alternate embodiment, an electrically powered vehicle 200 includes a battery pack 202, an electric motor 204 and a motor controller package 206. As illustrated, electric drive motor 204 is mounted at the rear 208 of the vehicle with battery pack 202 and motor controller 206 mounted in a compartment 210 above the electric motor. In other variations, battery pack 202, motor 204 and controller package 206 may be mounted at alternate locations in the vehicle, for example at or near the front of the vehicle or in a mid-body motor configuration or at different locations in the vehicle.

As illustrated, a pair of air ducts 212, 214 having inlet openings 216 at or adjacent front wheel wells 218 of vehicle 200. Blowers 220 located in each of ducts 212, 214 are driven by fixed or variable speed motors 222 mounted in or on ducts 212, 214. Blowers 220 may be either axial fans or centrifugal blowers and are selected to generate a turbine-like or engine-like sound in operation. Ducts 212, 214 may be designed and configured with restrictions, baffles, expansion chambers and other features to dampen unwanted frequency sounds and/or enhance desired frequency sounds.

In one embodiment, intake dampers 224 are positioned in ducts 212, 214 between inlet openings 216 and blowers 220. Dampers 224 may be positioned with linear or rotary actuators 226 to regulate the flow of air to the blowers. The speed of blowers 220 and/or position of dampers 224 may be controlled based on the speed of vehicle 200, the rpm of drive motor 204 and/or the temperature of the drive motor, battery pack 202 or motor controller 206. In one embodiment, the speed of blowers 220 is controlled based on the speed of vehicle 200 or rpm of drive motor 204 while the position of dampers 224 is based on the temperature of the drive motor, battery pack 202 or motor controller 206. The speed of blowers 220 may be controlled to vary the dB level of the sound generated by the blowers as generally illustrated in FIG. 2. In this manner, blowers 220 may be operated at the speed required to generate the desired sound levels while supplying the needed amount of cooling air to the electrical components of vehicle 200.

In one embodiment, one of ducts 212, 214 discharges into compartment 210 to provide cooling to battery pack 202 or motor controller 206 while the other duct is configured to discharge cooling air directly on or adjacent to drive motor 204. In this variation, the position of each of dampers 224 may be independently controlled based on the temperature in compartment 110 or the temperature of drive motor 204 as measured by temperature sensors 228 mounted in the compartment and on or adjacent the drive motor. In one embodiment, sensors 228 are connected to a controller 230 that is programmed to control blowers 220 and dampers 224. Controller 230 may be connected to a manually activated switch 232, allowing the driver the option of operating vehicle 200 with blowers on or off, in a silent mode, with the blowers de-energized. In one variation, controller 230 is programmed to operate blowers 220 for a predetermined period of time after drive motor 204 is de-energized to prevent over heating. In another variation, controller 230 is programmed to operate blowers 220 based on the temperature of the drive motor 204 and/or battery pack 202 and motor controller 206, regardless of whether or not the drive motor is energized.

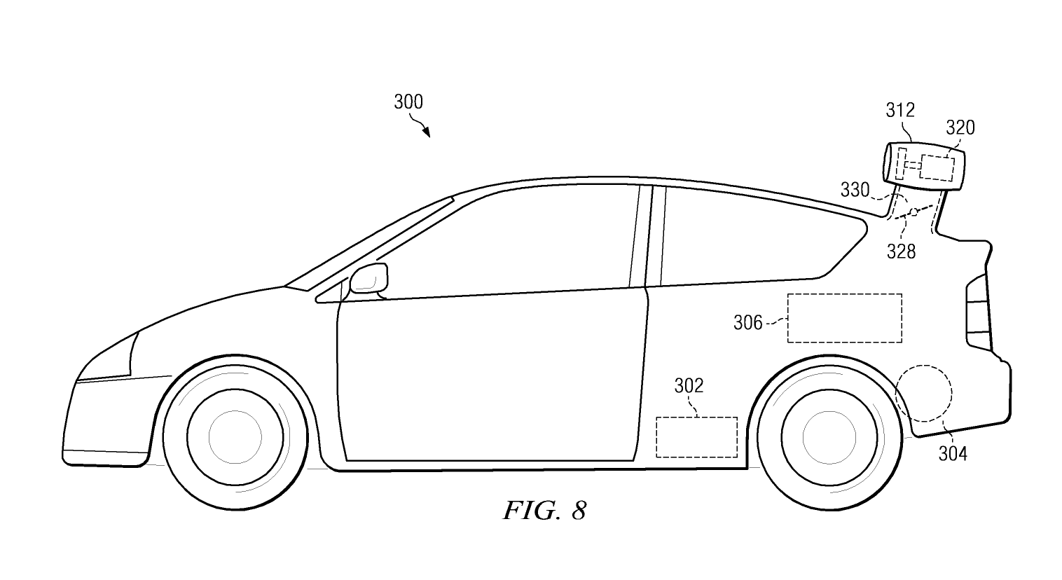

Turning to FIG. 8, in another variation, an electrically powered vehicle 300 includes a battery or battery pack 302, an electric drive motor 304 and a motor controller package 306. In this variation, a blower 312 is mounted externally on the body of vehicle 300. Blower 312 is driven by a variable speed electric drive motor 320 to direct air onto battery pack 302, motor controller 306 and/or electric drive motor 304. The speed of motor 320 and/or blower 312 may be controlled as described above to vary the frequency and volume of sound generated by the blower. A damper 328 may be mounted in the outlet 330 of blower 312 to regulate the flow of air directed to onto battery pack 302, motor controller 306 and/or electric drive motor 304. Damper 328 may be positioned with a manual or electric actuator (not shown).

It will be appreciated by those skilled in the art having the benefit of this disclosure that this electrically propelled vehicle having electric sound-producing blower/cooler provides a rotary air mover and sound generator for an electrically propelled vehicle. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1 An electrically powered passenger vehicle comprising:
an electric drive motor operatively coupled to one or more of the vehicle's wheels for rotating the vehicle's wheels to propel the vehicle, wherein the vehicle has variable performance parameters;
a battery pack for powering the electric drive motor;
a first controller for controlling the speed of the vehicle;
a rotary air mover and sound generator for supplying cooling air to the electric drive motor and generating a variable sound having at least one variable sound parameter as the vehicle moves, the rotary air mover and sound generator having an air inlet and an air outlet;
a motor for driving the rotary air mover and sound generator;
a second controller for controlling the speed of the rotary air mover and sound generator, the controller controlling the speed of the rotary air mover and sound generator to change the variable parameter of sound generated by the rotary air mover and sound generator such that the sound parameter of sound generated by the rotary air mover and sound generator varies with one of the vehicle's performance parameters.

2. The vehicle of claim 1 wherein the vehicle's performance parameters include the speed of the vehicle, acceleration, deceleration, the position of the first controller and the speed of the drive motor.

3. The vehicle of claim 1 wherein the sound parameters include volume and frequency.

4. The vehicle of claim 1 wherein the sound parameters include constant tone, variable tone and interrupted tone.

5. The electrically powered vehicle of claim 1 further wherein the rotary air mover and sound generator comprises one of an axial fan or a centrifugal blower.

6. The electrically powered vehicle of claim 1 further comprising a resonating chamber connected to the outlet of the rotary air mover and sound generator.

7. An electrically powered passenger vehicle comprising:
an electric drive motor operatively coupled to one or more of the vehicle's wheels for rotating the vehicle's wheels to propel the vehicle, wherein the vehicle has variable performance parameters;
a battery pack for powering the electric drive motor;
a first controller for controlling the speed of the vehicle;
a combination rotary air mover and sound generator for generating a sound having at least one variable sound parameter as the vehicle moves, the rotary air mover and sound generator having an air inlet and an air outlet;
a motor for driving the rotary air mover and sound generator;
a second controller for controlling the rotary air mover and sound generator, the controller controlling the rotary air mover and sound generator to change the variable parameter of sound generated by the rotary air mover and sound generator such that the sound parameter of sound generated by the rotary air mover and sound generator matches a selected one of the vehicle's performance parameters.

8. The electrically powered vehicle of claim 7 wherein the rotary air mover and sound generator comprises an axial fan and wherein the second controller controls the variable parameter of sound by one of opening or closing a damper in one of the air inlet or air outlets.

9. The electrically powered vehicle of claim 7 wherein the rotary air mover and sound generator comprises a centrifugal blower and wherein the second controller controls the variable parameter of sound by one of opening or closing a damper in one of the air inlet or air outlets.

10. The electrically powered vehicle of claim 7 further comprising a manual switch for actuating the motor for driving the rotary air mover and sound generator.

11. The electrically powered vehicle of claim 7 further comprising a motion sensor for detecting the speed of the vehicle and wherein the second controller controls the variable parameter of sound based on the speed of the vehicle.

12. The electrically powered vehicle of claim 7 further comprising a sensor for detecting the speed of the electric drive motor and wherein the second controller controls the variable parameter of sound based on the speed of the speed of the electric drive motor.

13. The electrically powered vehicle of claim 7 further comprising a sensor for detecting the acceleration of the vehicle and wherein the second controller controls the variable parameter of sound based on the speed of the acceleration of the vehicle.

14. The electrically powered vehicle of claim 7 further comprising a resonating chamber connected to one of the inlet or the outlet of the rotary air mover and sound generator.

15. The electrically powered vehicle of claim 7 wherein the rotary air mover and sound generator comprises a axial blower and wherein the second controller controls the variable parameter of sound by one of opening or closing a damper in one of the air inlet or air outlets.

16. An apparatus for simulating the sound of a conventionally powered gasoline or diesel powered engine in an electrically powered passenger vehicle having an electric drive motor operatively coupled to one or more of the vehicle's wheels for rotating the vehicle's wheels to propel the vehicle, wherein the vehicle has variable performance parameters;
a rotary air mover and sound generator mounted on the vehicle for supplying cooling air to the electric drive motor and for generating a variable sound having at least one variable sound parameter, the rotary air mover and sound generator having an air inlet and an air outlet;
a motor for driving the rotary air mover and sound generator; and
a controller for controlling the rotary air mover and sound generator, the controller controlling the rotary air mover and sound generator to change the variable parameter of sound generated by the rotary air mover and sound generator such that the sound parameter of sound generated by the rotary air mover and sound generator matches a selected one of the vehicle's performance parameters.

17. The apparatus of claim 16 wherein the controller controls the rotary air mover and sound generator such that a sound parameter of the sound generated by the rotary air mover and sound generator varies linearly with one of the speed or acceleration of the vehicle.

18. The apparatus of claim 16 wherein the controller controls the rotary air mover and sound generator such that a sound parameter of the sound generated by the rotary air mover and sound generator varies non-linearly with one of the speed or acceleration of the vehicle.

19. The apparatus of claim 16 wherein the rotary air mover and sound generator comprises an axial fan having adjustable pitch blades and wherein the sound parameter is varied by changing the pitch of the blades of the axial fan.

20. The apparatus of claim 16 wherein the rotary air mover and sound generator comprises a centrifugal blower and wherein the sound parameter is varied by changing the speed of the blower.
